(19) United States
(12) Patent Application Publication
(10) Pub. No.: US 2007/0099558 A1
(43) Pub. Date: May 3, 2007

(54) Hood assembly

(76) Inventors: Howard James Oagley, Louisville, KY (US); Paul Bryan Cadima, Prospect, KY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(21) Appl. No.: 11/263,307

(22) Filed: Oct. 31, 2005

(51) Int. Cl. A62C 2/06

(52) U.S. Cl. 454/257

(57) ABSTRACT

A hood assembly includes a hood body having an inner surface and an outer surface. The hood body extends between an inlet end and an exhaust end, and the hood body defining a hood cavity between the inlet end and said exhaust end. Airflow is channeled into the hood cavity through the inlet end and is configured to be exhausted into an exhaust duct through the exhaust end. A transition element extends from the exhaust end. The transition element has an inner surface and an outer surface, and the transition element includes a mounting portion configured to be coupled to the exhaust duct. The outer surface of the transition element is configured to engage an outer surface of the exhaust duct when the mounting portion is coupled to the exhaust duct.

### BACKGROUND OF THE INVENTION

This invention relates generally to an appliance exhaust system, and, more particularly, to a transition element used in assembling the appliance exhaust system.

Ovens and ranges tend to produce undesirable gases and/or fumes during a cooking process which may be released into the surrounding environment. As a result, a separate venting system, e.g. a range hood, is typically installed proximate the oven and/or range to facilitate reducing the release of such gases and/or fumes into the environment by capturing the gases and/or fumes released. Known range hoods include a hood body defining a hood cavity therein. An electric fan/blower is typically installed within the hood cavity to draw the gases and/or fumes into the hood cavity and then channel the gases and/or fumes to an exhaust duct, wherein the gases and/or fumes are vented outside of the home or building. At least some known range hoods include an inner transition element coupled to the hood body within the hood cavity. An exhaust end of the inner transition is typically received within and coupled to the exhaust duct. As such, the air drawn into the hood cavity may be channeled directly into the exhaust duct.

However, assembly of these known range hoods may be difficult and time consuming. For example, problems may be encountered coupling the inner transition to the exhaust duct. Typically the installer of the ducting in the home is not the installer of the range hood. The length of the exhaust duct may be inadequate for mounting the inner transition thereto. For example, the exhaust duct may be too short or improperly placed, requiring the range hood installer to provide flexible ducting to the end of the exhaust duct. The flexible ducting reduces the efficiency of the range hood and tends to accumulate grease and other impurities along the inner surface of the flexible ducting. In contrast, the exhaust duct may be too long, requiring the range hood installer to remove a portion of the exhaust duct to properly position the range hood.

Other assembly problems exist in installing known range hoods. For example, at least some known range hoods are “built-in range hoods” and are mounted within a decorative cabinet. During assembly, portions of the cabinet are typically removed to access the range hood and to install and mount the range hood within the cabinet. For example, mounting plates or fasteners may be accessed from within the cabinet and the connections made from the top and front of the range hood, such as, for example, screws for securing the inner transition to the exhaust duct, or screws for securing the range hood to the cabinet. Additionally, electrical wiring may be connected within the cabinet. During these processes, the cabinet may be damaged.

### BRIEF DESCRIPTION OF THE INVENTION

In one aspect, a hood assembly is provided including a hood body having an inner surface and an outer surface. The hood body extends between an inlet end and an exhaust end, and the hood body defining a hood cavity between the inlet end and said exhaust end. Airflow is channeled into the hood cavity through the inlet end and is configured to be exhausted into an exhaust duct through the exhaust end. A transition element extends from the exhaust end. The transition element has an inner surface and an outer surface, and the transition element includes a mounting portion configured to be coupled to the exhaust duct. The outer surface of the transition element is configured to engage an outer surface of the exhaust duct when the mounting portion is coupled to the exhaust duct.

In another aspect, a hood assembly transition element is provided including a base portion having an inner surface and an outer surface. The base portion defines a transition element cavity, and the base portion is configured to extend from a hood body. The hood assembly transition element also includes a mounting portion having an inner surface and an outer surface, wherein the mounting portion is configured to be coupled to an exhaust duct. The outer surface of the mounting portion is configured to engage an outer surface of the exhaust duct when the mounting portion is coupled to the exhaust duct.

In a further aspect, a method of assembling a hood assembly to an exhaust duct is provided, wherein the hood assembly includes a hood body and a transition element. The method includes locating a mounting portion of the transition element proximate an end of the exhaust duct, and securing an outer surface of the transition element to an outer surface of the exhaust duct using a fastening member.

### BRIEF DESCRIPTION OF THE DRAWINGS

FIG. 1 is an exploded perspective view of a hood assembly.

FIG. 2 is an assembled perspective view of the hood assembly shown in FIG. 1.

FIG. 3 is a front elevational view of the hood assembly shown in FIG. 1.

FIG. 4 is a side elevational view of the hood assembly shown in FIG. 1.

FIG. 5 is an enlarged view of a portion of the hood assembly taken along area 5-5 shown in FIG. 4.

### DETAILED DESCRIPTION OF THE INVENTION

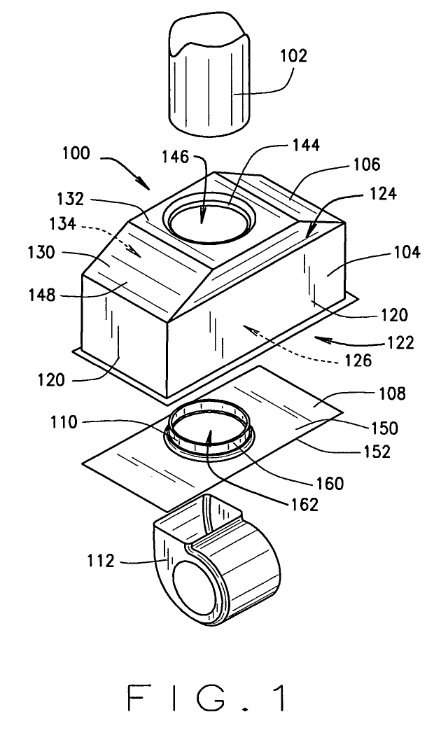

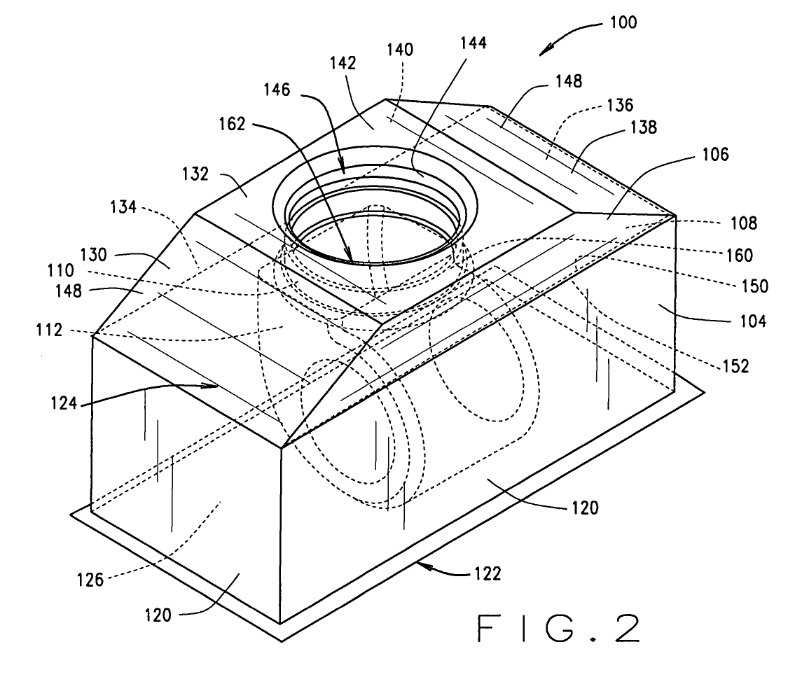

FIG. 1 is an exploded perspective view of a hood assembly 100, and FIG. 2 is an assembled perspective view of hood assembly 100. Hood assembly 100 is configured to be mounted above a cooking appliance (not shown), such as an oven or range for removal of gases and/or fumes released from the cooking appliance. Hood assembly 100 is also configured to be mounted to or in communication with an exhaust duct 102. Exhaust duct 102 channels the gases and/or fumes from hood assembly 100.

Hood assembly 100 includes a hood body 104 having a transition element 106 extending therefrom, and a plate member 108 mounted therein. Plate member 108 includes an inner transition element 110. A blower assembly 112 is coupled to the plate member 108 in communication with inner transition element 110.

In an exemplary embodiment, hood body 104 is fabricated from a rigid material, such as a metal material. Hood body 104 includes a plurality of side walls 120 extending between an inlet end 122 and an exhaust end 124. A hood cavity 126 is defined by side walls 120. In one embodiment, side walls 120 are planar, however, side walls 120 may have curved or irregular shapes. One side wall 120 defines a front wall and a generally opposing side wall 120 defines a rear wall. Airflow is drawn into hood cavity 126 and is exhausted from hood cavity 126 through exhaust end 124. In one embodiment, exhaust end 124 is generally opposed to inlet end 122.

In an exemplary embodiment, transition element 106 is integrally formed with hood body 104 and is positioned at exhaust end 124 of hood body 104. Transition element 106 includes a base or transition portion 130 and a mounting portion 132. Additionally, transition element 106 defines a transition element cavity 134. Base portion 130 extends from hood body 104 and includes an inner surface 136 facing transition element cavity 134 and an outer surface 138 exposed to an exterior of transition element 106. Additionally, mounting portion 132 includes an inner surface 140 facing transition element cavity 134 and an outer surface 142 exposed to an exterior of transition element 106. Mounting portion 132 also includes a collar 144 surrounding an exhaust opening 146. Collar 144 is inwardly turned and extends toward transition element cavity 134. As such, outer surface 142 of mounting portion 132 along collar 144 generally faces opening 146, and inner surface 140 of mounting portion 132 along collar 144 generally faces transition element cavity 134. Collar 144 is configured to receive exhaust duct 102 during assembly of hood assembly 100. Opening 146 is sized slightly larger than exhaust duct 102 such that exhaust duct 102 may be received within collar 144. For example, opening 146 may be between approximately one and ten percent larger than exhaust duct 102. When exhaust duct 102 is received within opening, the outer surface of exhaust duct 102 faces outer surface 142 of mounting portion 132 along collar 144, and may engage portions of outer surface 142. In one embodiment, base portion 130 includes inclined surfaces 148 extending from side walls 120 of hood body 104 generally toward mounting portion 132. Inclined surfaces 148 facilitate directing airflow generally toward opening 146 such that the airflow may be exhausted from hood assembly 100. Additionally, inclined surfaces 148 reduce the overall size and weight of hood assembly 100.

In an alternative embodiment, rather than being integrally formed, transition element 106 is coupled to exhaust end 124 of hood body 104. For example, transition element 106 may be coupled to a top wall (not shown) of hood body 104 via screws (not shown). In one embodiment, the screws may be attached from within hood cavity 126 for ease of installation.

As shown in FIG. 2, plate member 108 includes an upper surface 150 and a lower surface 152. Plate member 108 is received within hood cavity 126 such that upper surface 150 is facing transition element cavity 134 and lower surface 152 is exposed to and facing hood cavity 126. Plate member 108 may be mounted to hood body 104 proximate exhaust end 124. When mounted, plate member 108 defines an upper surface of hood cavity 126 and restricts airflow into transition member cavity 134.

Inner transition element 110 extends from a portion of plate member 108. In one embodiment, inner transition element 110 is integrally formed with plate member 108. Alternatively, inner transition element 110 may be coupled to plate member 108. Inner transition element 110 includes a collar 160 extending from upper surface 150 of plate member 108. Collar 160 surrounds an opening 162 that extends through plate member 108 and inner transition element 110. Generally, the air within hood cavity 126 is directed through opening 162. In the exemplary embodiment, when plate member 108 is mounted to hood body 104, opening 162 is substantially aligned with opening 146 in transition element 106.

During assembly, blower assembly 112 is mounted to lower surface 152 of plate member 108 and is contained within hood cavity 126. Blower assembly 112 may be mounted proximate opening 162 such that the air within hood cavity 126 is channeled through opening 162 by blower assembly 112.

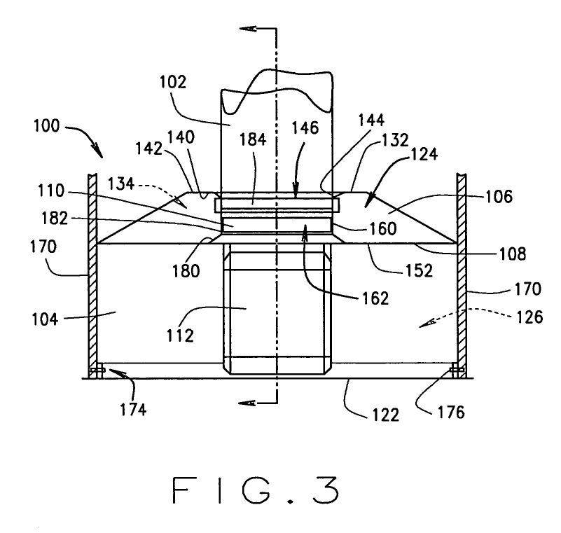

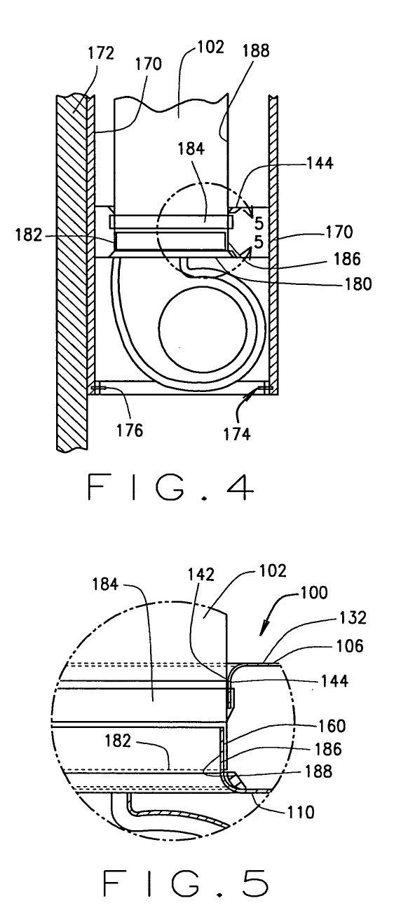

FIGS. 3 and 4 are front and side elevational views, respectively, of hood assembly 100 in an assembled state. Additionally, hood assembly 100 is illustrated as being positioned with respect to exhaust duct 102, and a supporting structure 170, such as, for example, a cabinet or a wall 172. In an exemplary embodiment, a liner or supporting member 174 is mounted at inlet end 122 of hood body 104. Liner 174 facilitates mounting or coupling hood assembly 100 to supporting structure 170. Liner 174 may be attached to supporting structure 170 via a fastening mechanism 176, such as, for example, a screw. The fastening mechanism 176 may be installed from inside or below hood cavity 126. As such, an installer does not need to access the inside of supporting structure to attach hood assembly 100 thereto.

As illustrated in FIGS. 3 and 4, when hood assembly 100 is assembled, plate member 108 is coupled to hood body 104 at exhaust end 124. Blower assembly 112 is mounted to plate member 108 proximate opening 162 of inner transition element 110. In one embodiment, hood assembly 100 includes a damper assembly 180 coupled to one of inner transition element 110, plate member 108, or blower assembly 112. Damper assembly 180 facilitates controlling an amount of air exhausted from hood assembly 100.

An exemplary method of assembly and coupling of hood assembly 100 and exhaust duct 102 is described herein, with reference to FIGS. 3 and 4. Prior to assembly and coupling, exhaust duct 102 is positioned with respect to supporting structure 170 at a predetermined height. In an exemplary embodiment, transition element 106 and hood body 104 are integrally formed. Exhaust duct 102 is loaded through opening 146. Collar 144 surrounds exhaust duct 102 such that outer surface 142 of mounting portion 132 substantially engages or interfaces with the outer surface of exhaust duct 102. Additionally, a portion of exhaust duct 102 extends beyond an end 182 of collar 144 for a predetermined length. Once transition element 106 is positioned with respect to exhaust duct 102, a fastening member 184 is used to secure transition element 106 to exhaust duct 102. Fastening member 184 is applied from below hood assembly 100, such as through hood cavity 126. As a result, the installer does not need to access the inside of supporting structure 170 to attach transition element 106 to exhaust duct 102. In an exemplary embodiment, fastening member 184 is duct tape, however other types of fastening members may be used, such as, for example, a screw. The duct tape is secured to inner surface 140 of collar 144 and is simultaneously secured to the outer surface of exhaust duct 102.

Once transition element 106 and hood body 104 are secured to exhaust duct 102, plate member 108 is coupled to hood body 104 within hood cavity 126. As plate member 108 is loaded into hood cavity 126, inner transition element 110 is positioned within exhaust duct 102. Specifically, collar 160 is placed within exhaust duct 102 such that an outer surface 186 of collar 160 is positioned proximate to, and in one embodiment, engages or interfaces with, an inner surface 188 of exhaust duct 102. As a result, air channeled through inner transition element 110 is directed into exhaust duct 102. Alternatively, collar 160 may extend around the outer surface of exhaust duct 102.

Once plate member 108 is coupled to hood body 104, blower assembly 112 is coupled to lower surface 152 of plate member 108. Blower assembly 112 may include a single blower or a double blower. In one embodiment, electrical connections for blower assembly 112 are made prior to coupling blower assembly 112 to plate member 108, and may be made prior to coupling plate member 108 to hood body 104. The electrical connections may be made and housed within transition element cavity 134 and are hidden from view by plate member 108. As such, the installer does not need to access the inside of supporting structure 170 to make any electrical connections, but rather, the connections are made from below hood assembly 100 or within hood cavity 126.

Once transition element 106 and hood body 104 are secured to exhaust duct 102, liner 174 may be coupled to inlet end 122 of hood body 104. Additionally, liner 174 is coupled to supporting structure 170. The connections are made from below hood assembly 100 or within hood cavity 126.

FIG. 5 is an enlarged view of a portion of hood assembly 100 taken along area 5-5. FIG. 5 illustrates an exemplary coupling of hood assembly 100 and exhaust duct 102. Transition element 106 is secured to exhaust duct 102 by fastening member 184, such as, for example, duct tape. Collar 144 surrounds exhaust duct 102 such that outer surface 142 of mounting portion 132 substantially engages or interfaces with the outer surface of exhaust duct 102. Additionally, a portion of exhaust duct 102 extends beyond an end 182 of collar 144 for a predetermined length. Inner transition element 110 is positioned within exhaust duct 102 such that collar 160 extends into exhaust duct 102. Outer surface 186 of collar 160 engages inner surface 188 of exhaust duct 102.

As illustrated in FIG. 5, collar 144 of transition element 106 extends in a first or downward direction, and collar 160 of inner transition element 110 extends in a generally opposing second or upward direction. In an exemplary embodiment, transition element 106 is spaced apart from inner transition element 110 such that a gap extends between elements 106 and 110. Alternatively, portions of elements 106 and 110 may overlap one another. In an exemplary embodiment, collars 144 and 160 of transition element 106 and inner transition element 110, respectively, have different diameters. For example, collar 144 may have a larger diameter than collar 160 such that collar 144 extends along an outer surface of exhaust duct 102 and collar 144 extends along inner surface 188 of exhaust duct 102.

A hood assembly is provided that may be installed in a cost effective and reliable manner. The hood assembly includes a reverse transition element having a collar extending inwardly or downward that is configured to extend around an outer portion of the exhaust duct. As such, the collar may be secured to the exhaust duct from below the hood assembly. The installer may make electrical connections and fixture connections from below the hood assembly. As a result, damage to the cabinet that the hood assembly is installed into is reduced. Additionally, assembly time may be reduced.

While the invention has been described in terms of various specific embodiments, those skilled in the art will recognize that the invention can be practiced with modification within the spirit and scope of the claims.

1. A hood assembly comprising:
a hood body having an inner surface and an outer surface, said hood body extending between an inlet end and an exhaust end, said hood body defining a hood cavity between said inlet end and said exhaust end, wherein airflow is channeled into said hood cavity through said inlet end and is configured to be exhausted into an exhaust duct through said exhaust end; and
a transition element extending from said exhaust end, said transition element having an inner surface and an outer surface, and said transition element comprising a mounting portion configured to be coupled to the exhaust duct, wherein said outer surface of said transition element is configured to engage an outer surface of the exhaust duct when said mounting portion is coupled to the exhaust duct.

2. The hood assembly of claim 1 wherein said transition element and said hood body are integrally formed.

3. The hood assembly of claim 1 wherein said mounting portion of said transition element is inwardly turned toward said hood cavity.

4. The hood assembly of claim 1 further comprising a fastening member configured to couple said mounting portion of said transition element to the exhaust duct, wherein said fastening member is applied by a user through said hood cavity.

5. The hood assembly of claim 4 wherein said fastening member is duct tape.

6. The hood assembly of claim 1 wherein said inlet end and said outlet end are generally opposed to one another.

7. The hood assembly of claim 1 further comprising a liner extending from said inlet end, said liner configured to be secured to a mounting structure surrounding said hood assembly.

8. The hood assembly of claim 1 further comprising an inner transition element mounted to said hood body within said hood cavity.

9. The hood assembly of claim 8 wherein said inner transition element is configured to engage an end of the exhaust duct when said inner transition element is mounted to said hood body.

10. The hood assembly of claim 1 further comprising a blower assembly configured to draw air into said hood cavity and to exhaust air into the exhaust duct.

11. The hood assembly of claim 1 further comprising a damper assembly configured to restrict airflow into the exhaust duct.

12. A hood assembly transition element comprising:
a base portion having an inner surface and an outer surface, said base portion defining a transition element cavity, and said base portion configured to extend from a hood body; and
a mounting portion having an inner surface and an outer surface, said mounting portion configured to be coupled to an exhaust duct;
wherein said outer surface of said mounting portion is configured to engage an outer surface of the exhaust duct when said mounting portion is coupled to the exhaust duct.

13. The hood assembly transition element of claim 12 wherein said transition element and said hood body are integrally formed.

14. The hood assembly transition element of claim 12 wherein said mounting portion of said transition element is inwardly turned toward said hood cavity.

15. The hood assembly transition element of claim 12 further comprising a fastening member configured to couple said mounting portion of said transition element to the exhaust duct, wherein said fastening member is applied by a user through said hood cavity.

16. The hood assembly transition element of claim 15 wherein said fastening member is duct tape.

17. A method of assembling a hood assembly to an exhaust duct, wherein the hood assembly includes a hood body and a transition element, said method comprising:
locating a mounting portion of the transition element proximate an end of the exhaust duct; and
securing an outer surface of the transition element to an outer surface of the exhaust duct using a fastening member.

18. The method of claim 17 further comprising coupling the transition element to the hood body.

19. The method of claim 17 wherein said securing comprises securing an outer surface of the transition element to an outer surface of the exhaust duct using duct tape.

20. The method of claim 17 wherein said securing comprises securing an outer surface of the transition element to an outer surface of the exhaust duct from an interior portion of the hood body and the transition element.
